(19) United States
(12) Patent Application Publication
(10) Pub. No.: US 2026/0266416 A1
(43) Pub. Date: Sep. 10, 2026

(54) DISPLAY MOUNTING APPARATUS

(71) Applicant: Ergotron, Inc., St. Paul, MN (US)

(72) Inventor: Michael P. Barros, Minnetonka, MN (US)

(21) Appl. No.: 19/165,903

(22) PCT Filed: Feb. 9, 2024
(86) PCT No.: PCT/US2024/015213

§ 371 Date: Sep. 16, 2025

Related U.S. Application Data
(60) Provisional application No. 63/490,553, filed on Mar. 16, 2023.

(51) Int. Cl. F16M 11/10; F16M 11/20; F16M 11/24; F16M 13/02

(52) U.S. Cl. CPC F16M 11/105; F16M 11/2064; F16M 11/24; F16M 13/022

(57) ABSTRACT

A display mounting apparatus can hold one or more electronic displays above a work surface or in front of a structure. The display mounting apparatus can include a riser, one or more arm assemblies, and a collar. The one or more arm assemblies can be rotatably coupled to the collar through a sleeve, and the collar can be secured to the riser at a desired elevation via a lock mechanism (e g., a knob, lever, or the like). The arm assembly and the collar can be adapted to slide together relative to the riser when the collar is in a movable configuration. The one or more arm assemblies can be operable to translate (e.g., move, rotate, tilt, or the like) the one or more displays relative to the riser.

### CLAIM OF PRIORITY

This patent application claims the benefit of priority of Barros, U.S. Provisional Patent Application Ser. No. 63/490,553, entitled “DISPLAY MOUNTING APPARATUS,” filed on Mar. 16, 2023 (Attorney Docket No 5983.479PRV), which is hereby incorporated by reference herein in its entirety.

### TECHNICAL FIELD

This document pertains generally, but not by way of limitation, to devices that can mount an electronic display above a work surface or in front of a structure.

### BACKGROUND

Mounting devices for electronic displays (e.g., flat panel displays, tablets, or the like) are commonly used in modern offices, at homes, and other places. Mounting devices can be used to position one or more electronic devices above a surface (e.g., a table, a work surface of a mobile workstation, or the like) or in front of a structure (e.g., a wall, cabinet, or the like). The display mounting devices can provide some articulation for one or more electronic displays to change their orientation (e.g., change the tilt angle, rotation, or height) relative to the surface or the structure.

### BRIEF DESCRIPTION OF THE DRAWINGS

The following drawings are illustrative of particular embodiments of the present invention and therefore do not limit the scope of the invention. The drawings are not to scale and are intended for use in conjunction with the explanations in the following detailed description. Like numerals may describe similar components in different views. Like numerals having different letter suffixes may represent different instances of similar components. The drawings illustrate generally, by way of example, but not by way of limitation, various embodiments discussed in the present document.

FIG. 1 is a perspective view of display mounting apparatus according to an example configuration of the current disclosure.

FIG. 2 is a top view of the display mounting apparatus of FIG. 1 as coupled to a work surface.

FIG. 3 is a perspective view of the arm of FIG. 1.

FIG. 4 is a partial cross-sectional view of the arm of FIG. 3.

FIG. 5 is a cross-sectional view of the collar of FIG. 1.

FIG. 6 is a side view of the knob of FIG. 1.

FIG. 7 is a perspective view of a sleeve according to an example configuration of the current disclosure.

FIG. 8 is a partial cross-sectional view of the display mounting apparatus of FIG. 1.

### OVERVIEW

This disclosure is directed to a display mounting apparatus. One or more electronic displays can be coupled to the display mounting apparatus. The display mounting apparatus can include a riser (e.g., a support column, pole, or the like), and one or more arm assemblies. The one or more arm assemblies can be operable to translate (e.g., move, rotate, tilt, raise or lower, or the like) the one or more displays.

For example, the display mounting apparatus can include a base, a riser, a collar, an arm assembly, and a display interface. The riser can be coupled to and extend from the base. The riser can be at least partially located within the collar, and the collar can be slidably engaged with the riser. The arm assembly can be coupled between the riser and the display interface. The arm assembly can be operable to translate the display interface relative to the riser. The arm assembly can be configured to change an angle of the display interface relative to the riser.

The display mounting apparatus can be coupled to a work surface or a structure (e.g., a wall, a desk, a pole, a cabinet, a rack, or the like). For example, the riser of the display mounting apparatus can be coupled (e.g., clamped, bolted, or the like) to a work surface. The one or more arm assemblies can be releasably coupled to the riser. The user of the display mounting apparatus can selectively change the position (e.g., a height) of the one or more arm assemblies relative to the riser. A lock mechanism (e.g., a knob, a lever, a clamp, or the like) can secure the one or more arm assemblies at a desired elevation relative to the work surface or the structure.

### DETAILED DESCRIPTION

The following detailed description is exemplary in nature and is not intended to limit the scope, applicability, or configuration of the invention in any way. Rather, the following description provides some practical illustrations for implementing exemplary embodiments of the present invention. Examples of constructions, materials, dimensions, and manufacturing processes are provided for selected elements, and all other elements employ that which is known to those of ordinary skill in the field of the invention. Those skilled in the art will recognize that many of the noted examples have a variety of suitable alternatives.

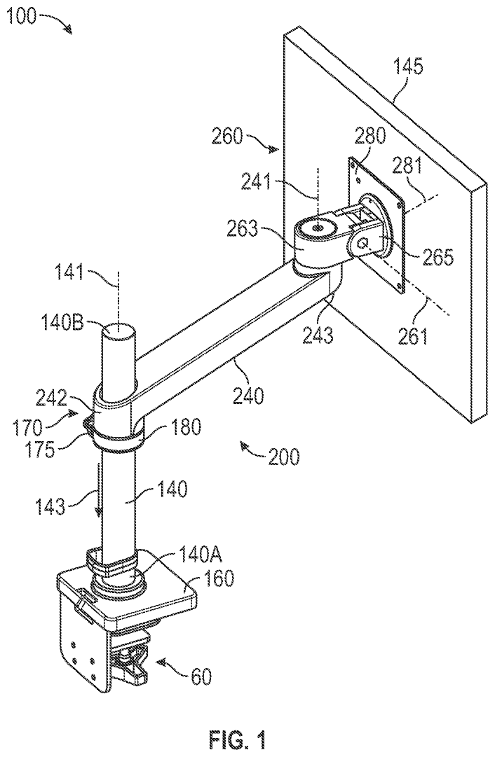

FIG. 1 shows an example of a display mounting apparatus that can implement various techniques of this disclosure. The display mounting apparatus 100 of FIG. 1 can include a base 160, a support column (e.g., a pole 140), and an arm assembly 200. In other example configurations, one or more arm assemblies can be coupled to the pole 140.

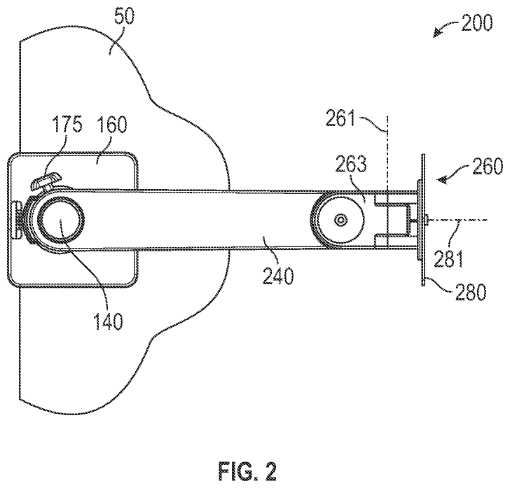

The base 160 can be coupled to a work surface 50 (e.g., coupled to an edge of the work surface 50 as illustrated in FIG. 2, coupled to the work surface through a hole, or free standing over the work surface, or the like). In some example configurations, a clamp assembly 60 can be coupled to the base 160 as illustrated in FIG. 1. The clamp assembly 60 can be adapted to clamp to an edge of the work surface 50 when the display mounting apparatus 100 positioned proximate the edge of the work surface 50. In other example configurations, the pole 140 can be coupled to a structure (e.g., a wall, cabinet, or the like).

The pole 140 can have a first portion 140A and a second portion 140B. The first portion 140A of the pole 140 can be coupled to the base 160, and the pole 140 can extending from the base 160 in a transverse direction towards the second portion 140B. The pole 140 can be formed from any engineering material including, but not limited to, steel, aluminum extrusion, cast aluminum, or the like. The pole 140 can have a hollow (e.g., a tube) or solid (e.g., a rod) body and formed at least partially in a round cross-section. The pole 140 can form a first axis 141 in a longitudinal direction extending from the first portion 140A to the second portion 140B. The first axis 141 can be generally in a vertical direction (e.g., perpendicular to the work surface 50).

In some example configurations, the arm assembly 200 can include an arm 240, a pivot assembly 260, and a display interface 280. The arm 240 can be rotatably coupled to the pole 140 proximate a first portion 242, and rotatably coupled to the pivot assembly 260 proximate the second portion 243 opposite the first portion 242. In other example configurations, the arm 240 can be a first arm, and the arm assembly can include a second arm rotatably coupled between the first arm and the pivot assembly. The second arm can be an extension arm having a fixed height or a height adjustable arm.

The pivot assembly 260 can include a pan bracket 263, and a tilt bracket 265. The pan bracket 263 can be rotatably coupled to the arm 240 about a second axis 241, and the tilt bracket 265 can be rotatably coupled to the pan bracket 263 about a third axis 261. The second axis 241 can be generally in a vertical direction (e.g., the second axis 241 and be parallel to the first axis 141), and the third axis 261 can be perpendicular to the second axis 241 (e.g., the third axis 261 can be oriented in a horizontal direction). The display interface 280 can be rotatably coupled to the tilt bracket 265 about a fourth axis 281. The fourth axis 281 can be perpendicular to the third axis 261.

An electronic display 145 can be coupled to the display interface 280 to position the electronic display 145 over a surface (e.g., the work surface 50), or in front of a structure (e.g., a wall, a cabinet, or the like). The arm assembly 200 can be adapted to translate the electronic display 145 (e.g., move, rotate, tilt, or the like) relative to the surface or the structure.

In some example configurations, the display mounting apparatus 100 can also include a collar 180 having a lock mechanism 170. In some example configurations the lock mechanism 170 can include a knob 175. In other example configurations, the lock mechanism 170 can include a lever, a clamp, or the like. The lock mechanism 170 can have a locked configuration and an unlocked configuration. In the locked configuration of the lock mechanism 170, the collar 180 can be in a fixed configuration (e.g., the collar 180 can be stationary relative to the pole 140), and in the unlocked configuration of the lock mechanism 170, the collar 180 can be in a movable configuration (e.g., the collar 180 can be enabled to translate or rotate relative to the pole 140).

The pole 140 can be at least partially located inside the collar 180, and the collar 180 can be slidably engaged with the pole 140. The collar 180 can translate along the pole 140 within the range of travel 143, and the collar 180 can be positioned anywhere along the length of the pole 140 within the range of travel 143 between the first portion 140A and the second portion 140B of the pole 140. The lock mechanism 170 (e.g., the knob 175) can be coupled to the collar 180 and the lock mechanism 170 can be operable to engage with the pole 140 to put the collar 180 in the fixed configuration (e.g., to secure the collar 180 at a desired elevation from the base 160). In the fixed configuration, the collar 180 can support the arm 240 to keep the arm 240 at a desired height relative to the base 160.

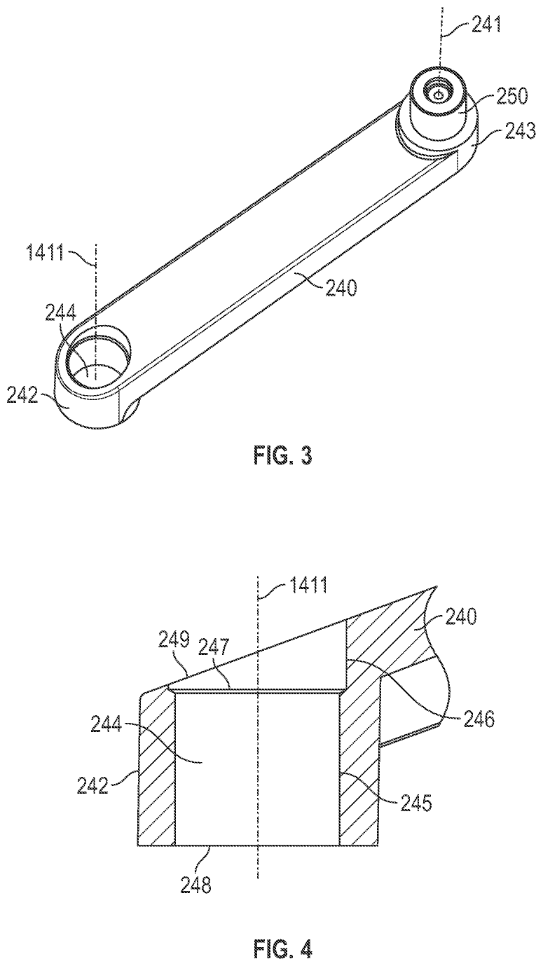

FIG. 3 is a perspective view of the arm 240 according to an example configuration of the current disclosure. The arm 240 can be elongated from a first portion 242 to a second portion 243. The arm 240 can be formed from any engineering material including, but not limited to, steel, cast aluminum, nylon, ABS, or the like. An aperture 244 can be formed proximate the first portion 242 and a post 250 can be formed proximate the second portion 243. The post 250 can be formed in a round cross-section and the post 250 can define the second axis 241. In some example configurations, the second portion 243 can be elevated relative to the first portion 242.

FIG. 4 is a partial cross-sectional side view of the first portion 242 of the arm 240 of FIG. 3. The arm 240 can have a first arm surface 248 and a second arm surface 249 opposite the first arm surface 248. The aperture 244 can extend from the first arm surface 248 to the second arm surface 249. The aperture 244 can be formed in a circular cross-section having a first diameter 245 proximate the first arm surface 248 and have a second diameter 246 proximate the second arm surface 249. In some example configurations, the second diameter 246 can be larger than the first diameter 245. The first diameter 245 and the second diameter 246 can be concentric at a fifth axis 1411. A ledge 247 can be formed as a transition region between the first diameter 245 and the second diameter 246.

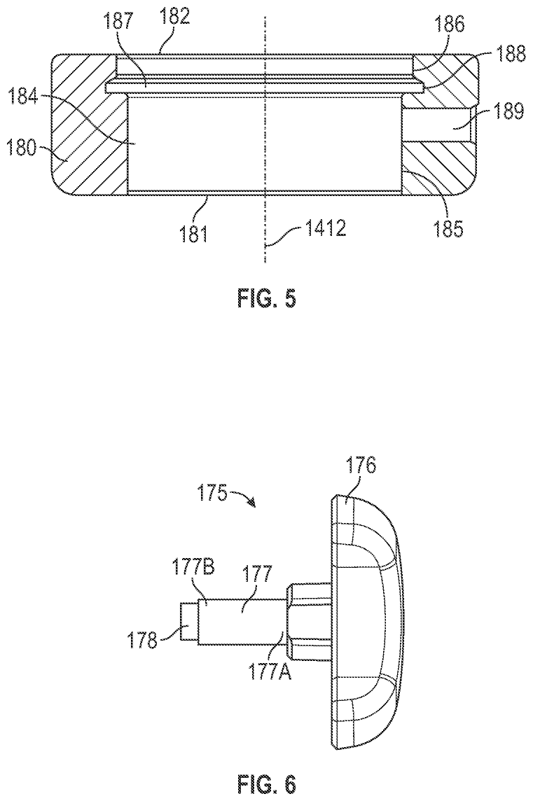

FIG. 5 is a cross-sectional side view of the collar 180 having a first collar surface 181 and a second collar surface 182 opposite the first collar surface 181. The collar 180 can be formed from any engineering material including, but not limited to, steel, cast aluminum, nylon, ABS, or the like. An opening 184 can be formed on the collar 180. The opening 184 can extend from the first collar surface 181 to the second collar surface 182. The opening 184 can have a circular cross-section having a first collar diameter 185 proximate the first collar surface 181 and a second collar diameter 186 proximate the second collar surface 182. The first collar diameter 185 can be adapted to receive the pole 140. The second collar diameter 186 can be larger than the first collar diameter 185. A recess 187 can be formed between the first collar diameter 185 and the second collar diameter 186. The recess 187 can have a third collar diameter 188. The third collar diameter 188 can be larger than the second collar diameter 186. The second collar diameter 186, the first collar diameter 185, and the third collar diameter 188 can be concentric at a sixth axis 1412.

A threaded hole 189 can be formed on the collar 180 between the first collar surface 181 and the second collar surface 182 in a section having the first collar diameter 185. The threaded hole 189 can extend from the opening 184 in a transverse direction (e.g., the threaded hole 189 can be perpendicular to the sixth axis 1412).

FIG. 6 is a side view of a knob 175 according to an example configuration of the current disclosure. The knob 175 can include a handle 176 and a threaded shaft 177. The threaded shaft 177 can extend from the handle 176 in a transverse direction between a first portion 177A and a second portion 177B. The first portion 177A of the threaded shaft 177 can be coupled to the handle 176 and a bead 178 can be coupled to the second portion 177B. The bead 178 can be made from an engineering material, including but not limited to, nylon, rubber, or the like. The threaded shaft 177 can be adapted to threadably engage with the threaded hole 189 of the collar 180.

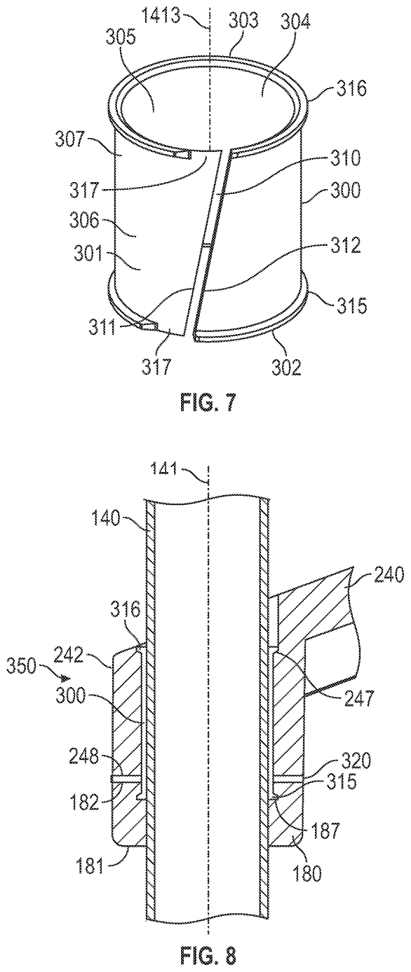

FIG. 7 is a perspective view of a sleeve 300 according to an example configuration of the current disclosure. The sleeve 300 can include a hollow sleeve body 301 extending from a first portion 302 to a second portion 303 opposite the first portion 302. The sleeve body 301 can be formed in a circular cross-section having a seventh axis 1413 at its center. The sleeve body 301 can have an inside surface 304 with an inside diameter 305 and an outside surface 306 with an outside diameter 307. The inside diameter 305 can be adapted to receive the pole 140.

A slit 310 can be formed on the sleeve body 301. The slit 310 can extend from the first portion 302 to the second portion 303 of the sleeve body 301. In some example configurations, the slit 310 can be parallel to the seventh axis 1413, in other configurations, the slit 310 can be formed in an angle to the seventh axis 1413. The slit 310 can create a first edge 311 and a second edge 312 across from the first edge 311 on the sleeve body 301.

The sleeve 300 can also include a first flange 315 and a second flange 316. The first flange 315 and the second flange 316 can be formed on the sleeve body 301 proximate to the first portion 302 and the second portion 303, respectively. The first flange 315 and the second flange 316 can be formed in a circular fashion extending from the first edge 311 to the second edge 312 of the slit 310. In some example configurations a clearance area 317 can be formed on the first flange 315 and the second flange 316 proximate to the slit 310. The clearance area 317 can be formed on one or both sides of the slit 310. In some example configurations, each of the first flange 315 and the second flange 316 can be formed as continuous flanges, in other configurations, they can be formed as intermittent flanges distributed around the periphery of the sleeve 300.

The second collar diameter 186 can be adapted to receive the outside diameter 307 of the sleeve 300, and the recess 187 of the collar 180 can be adapted to receive the first flange 315 of the sleeve 300. The first diameter 245 of the aperture 244 of the arm 240 can be adapted to receive the outside diameter 307 of the sleeve 300, and the ledge 247 of the arm 240 can be adapted to receive the second flange 316.

The sleeve 300 can be formed from a flexible engineering material, including, but not limited to, nylon. Teflon, ABS, or the like. In some example configurations, an edge of the slit 310 (e.g., the first edge 311 or the second edge 312) can be deflected towards the center of the sleeve 300 such that the outside diameter 307 can be reduced to install the sleeve 300 inside a hollow object (e.g., inside the opening 184 of the collar 180, inside the aperture 244 of the arm 240) as it will be apparent in the following sections.

FIG. 8 is a partial cross-sectional side view of the interface between the arm 240 and the pole 140 of the display mounting apparatus 100 of FIG. 1 according to an example configuration of the current disclosure. The collar 180 can be located below the first portion 242 of the arm 240 such that the fifth axis 1411 can coincide with the sixth axis 1412. The first arm surface 248 can face the second collar surface 182. A washer 320 can be located between the first arm surface 248 and the second collar surface 182. The sleeve 300 can be located at least partially inside the aperture 244 of the arm 240 and the opening 184 of the collar 180. The first flange 315 of the sleeve 300 can engage with the recess 187 of the collar 180 and the second flange 316 of the sleeve 300 can engage with the ledge 247 of the arm 240. The sleeve 300 can be configured to couple the arm 240 with the collar 180 to form a joint assembly 350.

The pole 140 can be inserted through the joint assembly 350 (e.g., inserted through the arm 240, the sleeve 300, and the collar 180). The fifth axis 1411, the sixth axis 1412, and the seventh axis 1413 can coincide with the first axis 141. The joint assembly 350 can be configured to slide along the pole 140 in parallel to the first axis 141. The joint assembly 350 can enable the arm 240 to rotate around the first axis 141 independent of the collar 180.

The knob 175 can be threadably engaged with the collar 180 (e.g., the threaded shaft 177 of the knob 175 can threadably engage with the threaded hole 189 of the collar 180). The user of the display mounting apparatus 100 can tighten the knob 175 (e.g., turn the knob 175 in a first direction relative to the collar 180) such that the bead 178 can press against the pole 140 to put the collar 180 in a fixed configuration, and the user of the display mounting apparatus 100 can loosen the knob 175 (e.g., turn the knob 175 in a second direction opposite the first direction relative to the collar 180) such that the bead 178 can disengage from the pole 140 to put the collar 180 in a movable configuration. In the fixed configuration, the collar 180 can be stationary relative to the pole 140 (e.g., the collar cannot translate along the first axis 141 relative to the pole 140) to keep the arm assembly 200 at a desired height relative the pole 140. In the movable configuration, the collar 180 can move relative to the pole 140 to enable a translation of the arm assembly 200 along the first axis 141 relative to the pole 140. In the movable configuration, the collar 180 can move together with the arm 240 simultaneously when the user of the display mounting apparatus 100 translates the arm in a direction parallel to the first axis 141. In any configuration of the collar 180 (e.g., in either the fixed configuration or the movable configuration), the arm 240 can rotate about the first axis 141 independent of the collar 180.

### Additional Notes and Aspects

Example 1 is a display mount assembly, comprising: a base; a riser having a first end coupled to the base and a second end opposite the first end, wherein the riser is elongated between the first end and the second end in a vertical direction forming a first axis; a collar having an opening adapted to receive the riser, wherein the collar is configured to translate along the riser through a range of travel between the first end and the second end of the riser; and an arm assembly having a display interface operably coupled to the collar and rotatably engaged with the riser; and wherein the arm assembly is operable to translate the display interface relative to the riser, wherein the collar and the arm assembly are adapted to translate relative to the riser simultaneously through the range of travel, and wherein the arm assembly is adapted to rotate relative to the riser about the first axis independent of the collar.

In Example 2, the subject matter of Example 1 optionally includes wherein the arm assembly includes a first arm assembly and a second arm assembly rotatably coupled to the riser, wherein the display interface includes a first display interface coupled to the first arm assembly and a second display interface coupled to the second arm assembly, and wherein the first arm assembly and the second arm assembly are operable to translate the first display interface and the second display interface relative to the riser.

In Example 3, the subject matter of any one or more of Examples 1-2 optionally include wherein the arm assembly includes: an arm having a first portion and a second portion opposite the first portion, wherein the arm is rotatably coupled to the riser about the first axis proximate the first portion of the arm; and a pivot assembly rotatably coupled to the arm about a second axis parallel to the first axis proximate the second portion of the arm.

In Example 4, the subject matter of Example 3 optionally includes a sleeve including: a sleeve body extending from a first portion to a second portion, the sleeve body includes an inside surface adapted to receive the riser and an outside surface; a first flange formed on the outside surface proximate the first portion of the sleeve body; and a second flange formed on the outside surface proximate the second portion of the sleeve body.

In Example 5, the subject matter of Example 4 optionally includes wherein the collar is elongated between a first portion and a second portion, wherein the opening extends through the collar between the first portion and the second portion and a recess is formed on the opening between the first portion and the second portion of the collar, and wherein the opening proximate the second portion of the collar is adapted to receive the first portion of the sleeve body enabling the first flange engage with the recess.

In Example 6, the subject matter of Example 5 optionally includes wherein the arm further comprises an aperture formed proximate the first portion of the arm, wherein the aperture includes a ledge, wherein the aperture is adapted to receive the second portion of the sleeve body enabling the second flange engage with the ledge, and wherein the arm is rotatably coupled to the riser at the aperture.

In Example 7, the subject matter of Example 6 optionally includes a knob including: a handle; and a threaded shaft having a first portion coupled to the handle and a second portion opposite the first portion, wherein the threaded shaft extends form the handle in a transverse direction between the first portion and the second portion; wherein the knob is threadedly engaged with the collar over the threaded shaft; wherein the knob is operable to translate relative to the collar towards or away from the riser to put the collar in a fixed configuration or a movable configuration, respectively, wherein the collar is enabled to translate in the range of travel relative to the riser in the movable configuration, and the collar is immobilized relative to the riser in the fixed configuration.

In Example 8, the subject matter of Example 7 optionally includes wherein the knob further includes a bead coupled to the second portion of the threaded shaft, and wherein the bead is adapted to engage with the riser in the fixed configuration of the collar and disengage from the riser in the movable configuration of the collar.

In Example 9, the subject matter of any one or more of Examples 7-8 optionally include a joint assembly formed by operably coupling the arm and the collar through the sleeve by engaging the first flange of the sleeve with the recess of the collar and engaging the second flange of the sleeve with the ledge of the arm, wherein the riser is at least partially located inside the joint assembly, wherein the joint assembly is configured to translate along the riser through the range of travel when the collar is in the movable configuration, and wherein the arm is configured to rotate relative to the collar and the riser irrespective of the collar being in the fixed configuration or in the movable configuration.

In Example 10, the subject matter of any one or more of Examples 3-9 optionally include wherein the pivot assembly comprises: a pan bracket rotatably coupled to the arm about the second axis proximate the second portion of the arm; and a tilt bracket rotatably coupled to the pan bracket about a third axis perpendicular to the second axis; wherein the display interface is rotatably coupled to the tilt bracket about a fourth axis perpendicular to the third axis.

In Example 11, the subject matter of Example 10 optionally includes wherein the arm assembly is configured to change an angle of the display interface relative to the riser.

Example 12 is a display mount assembly comprising: a support column coupled to a structure; a collar slidably engaged with the support column, wherein the support column is at least partially located inside the collar; a display interface; and an arm assembly rotatably coupled to the support column on a first portion and coupled to the display interface on a second portion opposite the first portion, wherein the arm assembly is configured to translate the display interface relative to the structure and the arm assembly configured to change an angle of the display interface relative to the support column; wherein the arm assembly is operably coupled to the collar, wherein the collar and the arm assembly are adapted to translate along the support column simultaneously, and wherein the arm assembly is adapted to rotate relative to the support column independent of the collar.

In Example 13, the subject matter of Example 12 optionally includes wherein the arm assembly comprises: an arm rotatably coupled to the support column about a first axis formed by the support column; and a pivot assembly rotatably coupled to the arm about a second axis proximate the second portion of the arm assembly, wherein the second axis is parallel to the first axis.

In Example 14, the subject matter of Example 13 optionally includes wherein the collar comprises: an opening having a recess, the opening is adapted to receive the support column; and wherein the collar is configured to translate relative to the support column through a range of travel.

In Example 15, the subject matter of Example 14 optionally includes a lock mechanism coupled to the collar; wherein the lock mechanism includes a locked configuration and an unlocked configuration, wherein, in the locked configuration, the lock mechanism is adapted to put the collar in a fixed configuration, and in the unlocked configuration, the lock mechanism is adapted to put the collar in a movable configuration.

In Example 16, the subject matter of Example 15 optionally includes wherein the lock mechanism comprises a knob including: a handle; and a threaded shaft having a first portion coupled to the handle and a second portion opposite the first portion, wherein the threaded shaft extends form the handle in a transverse direction from the first portion to the second portion, wherein the second portion is threadedly engaged with the collar; wherein the knob is operable to translate relative to the collar towards or away from the support column to put the collar in the fixed configuration or the movable configuration, respectively, wherein the collar is enabled to translate in the range of travel relative to the support column in the movable configuration, and the collar is immobilized relative to the support column in the fixed configuration.

In Example 17, the subject matter of any one or more of Examples 15-16 optionally include wherein the arm comprises: a first portion; a second portion; and an aperture having a ledge formed proximate the first portion, the aperture is adapted to receive the support column; wherein the arm is rotatably coupled to the support column at the aperture.

In Example 18, the subject matter of Example 17 optionally includes a sleeve including: a sleeve body extending from a first portion to a second portion; a first flange formed on the sleeve body proximate the first portion of the sleeve body; and a second flange formed on the sleeve body proximate the second portion of the sleeve body.

In Example 19, the subject matter of Example 18 optionally includes wherein the first portion of the sleeve is coupled to the collar such that the sleeve is at least partially located inside the opening of the collar and the first flange is engaged with the recess of the collar, a wherein the second portion of the sleeve is coupled to the arm such that the sleeve is at least partially located inside the aperture of the arm and the second flange is engaged with the ledge of the arm, and wherein the arm, the collar, and the sleeve together form a joint assembly.

In Example 20, the subject matter of Example 19 optionally includes wherein the support column is inserted into the collar, the sleeve, and the arm, and wherein the joint assembly is configured to translate along the support column through the range of travel when the collar is in the movable configuration, and wherein the arm is enabled to rotate relative to the collar and the sleeve independent of the collar in both the fixed configuration and the movable configuration of the collar.

Example 21 includes a method, apparatus, or system including any element of any of Examples 1-20.

Each of these non-limiting examples can stand on its own or can be combined in any permutation or combination with any one or more of the other examples.

The above detailed description includes references to the accompanying drawings, which form a part of the detailed description. The drawings show, by way of illustration, specific embodiments in which the present subject matter can be practiced. These embodiments are also referred to herein as “examples.” Such examples can include elements in addition to those shown or described. However, the present inventor also contemplates examples in which only those elements shown or described are provided. Moreover, the present inventor also contemplates examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. § 1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the present subject matter should be determined with reference to the appended claims, along with the full scope of equivalents to which such claims are entitled.

1. A display mount assembly, comprising:
a base;
a riser including a first end couplable to the base and a second end opposite the first end, wherein the riser is elongated between the first end and the second end in a vertical direction to at least partially define a first axis;
a sleeve including:
a collar having a sleeve body extending from a first sleeve portion to a second sleeve portion, the sleeve body including an opening inside surface configured to receive the riser, wherein and an outside surface;
a first flange formed on the outside surface proximate the first sleeve portion; and
a second flange formed on the outside surface proximate the second sleeve portion;
a collar is configured to translate along the riser through a range of travel along the riser between the first end and the second end, the collar including:
a first collar portion;
a second collar portion, the collar elongated between the first collar portion and the second collar portion; and
a channel configured to receive the riser, the channel extending through the collar between the first collar portion and the second collar portion, the channel including a recessed portion formed on the channel between the first collar portion and the second collar portion, the channel configured to receive at least a portion of the first sleeve portion to enable the first flange to engage with the recessed portion; and
an arm assembly having a display interface operably couplable to the collar and rotatably engageable with the riser; wherein, the arm assembly is including:
a display interface, the arm assembly operable to translate the display interface relative to the riser;
an arm including a first arm portion and a second arm portion opposite the first arm portion, the arm rotatably couplable to the riser about the first axis proximate the first arm portion; and
a pivot assembly rotatably couplable to the arm proximate the second arm portion about a second axis parallel to the first axis;
wherein:
the collar and the arm assembly are adapted to translate relative to the riser concurrently through the range of travel; and
wherein the arm assembly is adapted to rotate relative to the riser about the first axis independent of the collar.

2. The display mount assembly of claim 1, wherein the arm assembly includes a first arm assembly and a second arm assembly rotatably couplable to the riser;
wherein:
the display interface includes a first display interface coupled to the first arm assembly and a second display interface coupled to the second arm assembly; and
wherein the first arm assembly and the second arm assembly are operable to translate the first display interface and the second display interface relative to the riser.

3.-5. (canceled)

6. The display mount assembly of claim 1, wherein:
the arm further comprises an aperture formed proximate the first arm portion of the arm, and the aperture includes a ledge;
wherein the aperture is adapted to receive the second sleeve portion of the sleeve body to enable the second flange to engage with the ledge; and
wherein the arm is rotatably couplable to the riser at the aperture.

7. The display mount assembly of claim 6, further comprising a knob including:
a handle; and
a threaded shaft having a first shaft portion coupled to the handle and a second shaft portion opposite the first shaft portion, wherein the threaded shaft extending from the handle in a transverse direction between the first shaft portion and the second shaft portion;
wherein:
the knob is threadedly engageable with the collar over the threaded shaft;
wherein the knob is operable to translate relative to the collar towards or away from the riser to put the collar in a secured configuration or a movable configuration, respectively; and
wherein in the movable configuration the knob enables the collar is enabled to translate in the range of travel relative to the riser in the movable configuration, and in the secured configuration the collar limits or inhibits movement of the collar relative to the riser in the fixed configuration.

8. The display mount assembly of claim 7, wherein:
the knob further includes a bead coupled to the second shaft portion of the threaded shaft; and
wherein the bead is adapted to engage with the riser in the secured configuration of the collar and disengage from the riser in the movable configuration of the collar.

9. The display mount assembly of claim 7, further comprising a joint assembly formed by operably coupling the arm and the collar through the sleeve by engaging the first flange of the sleeve with the recessed portion of the collar and engaging the second flange of the sleeve with the ledge of the arm;
wherein:
the riser is at least partially locatable inside the joint assembly;
wherein the joint assembly is configured to translate along the riser through the range of travel when the collar is in the movable configuration; and
wherein the arm is configured to rotate relative to the collar and the riser irrespective of the collar being in the secured configuration or in the movable configuration.

10. The display mount assembly of claim 1, wherein the pivot assembly includes:
a pan bracket rotatably couplable to the arm about the second axis proximate the second arm portion of the arm; and
a tilt bracket rotatably coupled to the pan bracket about a third axis perpendicular to the second axis;
wherein the display interface is rotatably couplable to the tilt bracket about a fourth axis perpendicular to the third axis.

11. The display mount assembly of claim 10, wherein the arm assembly is configured to change an angle of the display interface relative to the riser.

12. A display mount assembly comprising:
a support column couplable to a structure;
a collar slidably engageable with the support column, wherein the support column is and configured to translate relative to the support column through a range of travel, the collar including a channel, the channel receiving at least partially located inside the collar portion of the support column, the channel including a recessed portion;
a display interface; and
an arm assembly rotatably operably couplable to the support column on a first portion and coupled to the display interface on a second portion opposite the first portion, collar, the arm assembly is configured to translate the display interface relative to the structure and the arm assembly configured to change an angle of the display interface relative to the support column, the arm assembly including:
wherein an arm including:
a first arm portion including an aperture, the arm assembly is operably rotatably couplable to the support column at the aperture about a first axis at least partially formed by the support column, the aperture including a ledge; and
a second arm portion opposite the first arm portion, the arm assembly couplable to the display interface at the second arm portion; and
a pivot assembly rotatably couplable to the arm about a second axis proximate the second arm portion, the second axis parallel to the first axis;
a lock mechanism couplable to the collar, the lock mechanism including a locked configuration where the lock mechanism is adapted to limit movement of the collar, and an unlocked configuration where the lock mechanism is adapted enable movement of the collar; and
a sleeve including:
a sleeve body extending from a first sleeve portion to a second sleeve portion;
a first flange formed on the sleeve body proximate the first sleeve portion, the first sleeve portion couplable to the collar such that the sleeve is at least partially locatable in the channel of the collar and the first flange is engageable with the recessed portion of the collar; and
a second flange formed on the sleeve body proximate the second sleeve portion, the second sleeve portion couplable to the arm such that the sleeve is at least partially locatable inside the aperture of the arm and the second flange is engageable with the ledge of the arm;
wherein:
the collar and the arm assembly are adapted to translate along the support column simultaneously, concurrently;
wherein the arm assembly is adapted to rotate relative to the support column independent of the collar; and
the arm, the collar, and the sleeve together form a joint assembly.

13.-15. (canceled)

16. The display mount assembly of claim 12, wherein the lock mechanism comprises a knob including:
a handle; and
a threaded shaft having a first shaft portion couplable to the handle and a second shaft portion opposite the first shaft portion, wherein the threaded shaft extends from the handle in a transverse direction from the first shaft portion to the second shaft portion, wherein the second shaft portion is threadedly engageable with the collar;
wherein:
the knob is operable to translate relative to the collar towards or away from the support column to put the lock mechanism in the locked configuration or the unlocked configuration, respectively, and
wherein the lock mechanism enables the collar is enabled to translate along at least a portion the range of travel relative to the support column in the unlocked configuration, and the lock mechanism limits or inhibits movement of the collar is immobilized relative to the support column in the locked configuration.

17.-19. (canceled)

20. The display mount assembly of claim 12, wherein:
the support column is inserted into the joint assembly including the collar, the sleeve, and the arm;
wherein the joint assembly is configured to translate along the support column through at least a portion of the range of travel when the lock mechanism is in the unlocked configuration; and
wherein the arm is enabled to rotate relative to the collar and the sleeve independent of the collar in both the locked configuration and the unlocked configuration of the lock mechanism.
